(19) United States
(12) Patent Application Publication
(10) Pub. No.: US 2006/0227944 A1
(43) Pub. Date: Oct. 12, 2006

(54) Method and apparatus for managing surveys across service centers

(75) Inventors: Jon Paden, Austin, TX (US); Kurt M. Joseph, Austin, TX (US); Bobby Sams, Austin, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/104,366

(22) Filed: Apr. 12, 2005

(51) Int. Cl. H04M 1/64

(52) U.S. Cl. 379/70; 379/76

(57) ABSTRACT

A survey system (102) interfaced with one or more service centers (108A-N) has a memory (102B), and a processor (102A). The processor is programmed to intercept (202) a calling party prior to the calling party accessing a service center, inform the calling party of a survey request, receive (208) from the calling party acceptance or rejection of the survey request, transfer (206) the calling party to the service center, and engage (214) the calling party in a survey after the calling party completes one or more tasks at the service center so long as said calling party chose to accept the survey request.

### FIELD OF THE INVENTION

This invention relates generally to survey methods, and more particularly to a method and apparatus for managing surveys across service centers.

### BACKGROUND OF THE INVENTION

Survey methods are generally used by a vendor as a means to improve services. Some of the most popular survey methods include mass mailings, automated emails, and synthesized speech systems such as an IVR (Interactive Voice Response) system for conducting a survey. Such survey methods, however, are static by design. That is, they do not provide a way for motivating a customer to engage in a survey, nor do they generate surveys in real-time with questions tailored to an observed behavior of a customer while utilizing the services of the vendor.

### SUMMARY OF THE INVENTION

Embodiments in accordance with the invention provide a method and apparatus for managing surveys across service centers.

In a first embodiment of the present invention, a computer-readable storage medium is coupled to one or more service centers. The storage medium has computer instructions for intercepting a calling party prior to the calling party accessing a service center, informing the calling party of a survey request, receiving from the calling party acceptance or rejection of the survey request, transferring the calling party to the service center, and engaging the calling party in a survey after the calling party completes one or more tasks at the service center so long as said calling party chose to accept the survey request.

In a second embodiment of the present invention, a survey system is coupled to one or more service centers. The survey system has a memory, and a processor coupled thereto. The processor is programmed to intercept a calling party prior to the calling party accessing a service center, inform the calling party of a survey request, receive from the calling party acceptance or rejection of the survey request, transfer the calling party to the service center, and engage the calling party in a survey after the calling party completes one or more tasks at the service center so long as said calling party chose to accept the survey request in the receive step.

In a third embodiment of the present invention, a method for conducting surveys including the steps of intercepting a calling party prior to the calling party accessing a service center, informing the calling party of a survey request, offering the calling party one or more incentives to motivate the calling party to accept the survey request, receiving from the calling party acceptance or rejection of the survey request, transferring the calling party to the service center, and engaging the calling party in a survey after the calling party completes one or more tasks at the service center so long as said calling party chose to accept the survey request.

### BRIEF DESCRIPTION OF THE DRAWINGS

FIG. 1 is block diagram of a survey system coupled to one or more service centers according to an embodiment of the present invention; and

FIG. 2 depicts a flow chart of a method operating in the service center according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

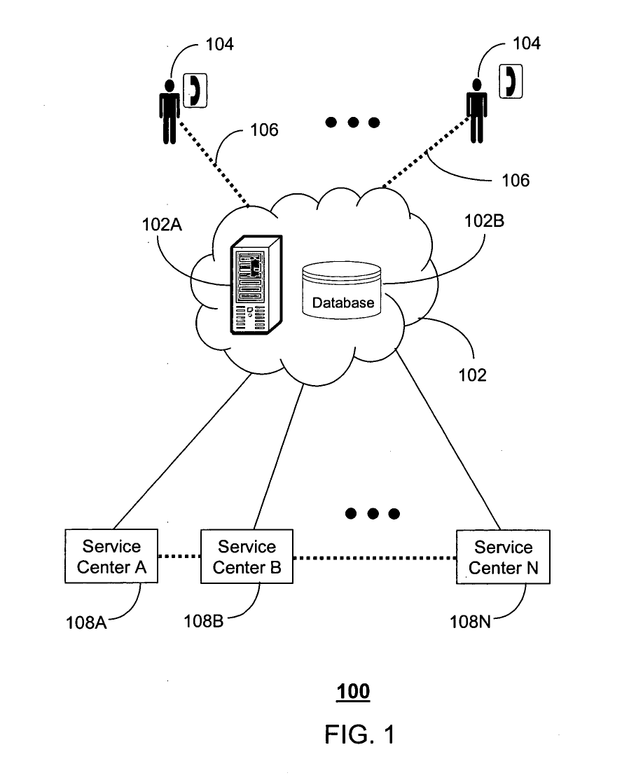

FIG. 1 is block diagram 100 of a survey system 102 coupled to one or more service centers 108 according to an embodiment of the present invention. The survey system 102 utilizes conventional technology such as a processor 102A and a memory 102B. The processor 102A can be represented by a conventional computer or server. The memory 102B utilizes a conventional media device (such as a high capacity disk drive) for storage purposes and can be used in the present application as a database for managing survey questions and corresponding feedback. Although the processor 102A and memory 102B are shown separately, they can be in the alternative an integral unit.

The survey system 102 is coupled to a conventional communication system (not shown) such as a PSTN (Public Switched Telephone Network), IP (Internet Protocol) network, and/or a wireless communication network. A calling party 104 can communicate with the survey system 102 by way of conventional communication lines 106 such as wire line or wireless services of the communication system. Accordingly, the communication system can be a hybrid of circuit switched, packet switched, and wireless technology providing a calling party that utilizes a conventional standard telephone, VoIP (Voice over IP) phone, or cell phone access to the survey system 102 in any geographic location covered by said system 106. The survey system 102 can operate as a conventional IVR (Interactive Voice Response) system supporting voice recognition, DTMF (Dual Tone Multi-Frequency) depression detection, text-to-speech conversion for exchanging messages with the calling party 104, and can incorporate the functions of an ACD (Automatic Call Distributor) for routing high volume calls.

In the present context any one of the service centers 108A-N can be represented by an IVR tailored for providing calling parties 104 a specific service (e.g., billing status, trouble reporting, changing services, procuring services, etc.) and/or by one or more agents each trained to provide the calling party 104 a similar service. It will be appreciated by one of ordinary skill in the art that a service center 108 can have other embodiments not described herein that are applicable to the invention as described by the scope and spirit of the claims below. As one might expect, the service centers 108 are managed by a service provider (e.g., a telecommunications company). The service provider can utilize the survey system 102 to manage and improve the quality, operational efficiency and customer care provided by the service centers 108.

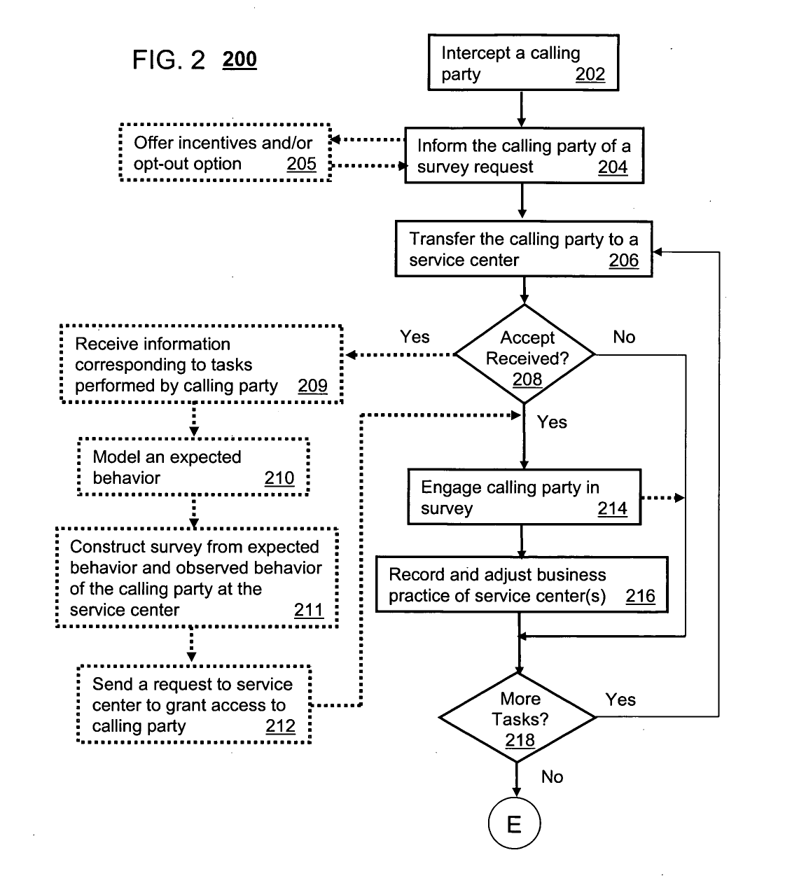

FIG. 2 depicts a flow chart of a method 200 operating in the survey system 102 according to an embodiment of the present invention. Method 200 begins with step 202 where the survey system 102 intercepts a calling party 104 prior to said calling party accessing a service center 108. The intercepting step 202 selects the calling party 104 from a number of callers according to one or more business rules including, but not limited to, a classification of the calling party, a region of the calling party, a random selection of the calling party, a portion of a phone number of the calling party, or other identification provided by the calling party.

The calling party 104 can be classified in any manner of interest to the service provider. For instance, a calling party 104 can be classified by the type of services procured (e.g., Internet, cellular phone, VoIP—Voice over IP). Alternatively, the calling party can be classified by the value of services procured (e.g., premium, mid-tier, standard). These classifications can be determined from an account number, caller ID, or other form of identification of the calling party 104. The identification can be cross-referenced with background information of the calling party stored in the database 102B. The calling party 104 can also be selected according to region (city or state) determined from, for example, the account number, or zip code provided verbally by the calling party or from caller ID information. Alternatively, the calling party 104 can be selected randomly according to any suitable algorithm. It should be evident to an artisan with skill in the art that any method for selecting a calling party can be applied to the claimed invention.

Following the intercepting step, the survey system 102 proceeds to step 204 where it verbally informs the calling party 104 that said party has been selected for a survey, and an acceptance or rejection of the survey is requested. The interactions between the calling party 104 and the survey system 102 can be verbal and/or include DTMF tone signals provided by the calling party 104 indicating his/her selection. In a supplemental embodiment, the request can also be accompanied in step 205 with one or more incentives and/or instructions for opting out of a survey at any time during the engaging step 214. The incentives are intended to motivate the calling party to accept the survey request of step 204. Any incentive can be used. For example, the calling party may be given a discount on service for participating in the survey, or a discounted or free offer of a new service not currently available to the calling party 104 for a limited time. To avoid frustrating the calling party 104 an opt-out option can be provided which can be invoked at any time by the calling party 104. This can be performed with, for example, a DTMF code such as “*#”, which the calling party 104 can use to exit a survey at will without disconnecting the calling party from the service center 108.

In step 206, the calling party 104 is transferred to a service center 108. In a first embodiment, the service center 108 can be chosen according to the needs identified by the calling party 104 in any one of steps 204-205. Alternatively, the calling party 104 can be transferred to a generic service center 106 that determines the needs of the calling party 105 and re-routes said party to another service center 108 if needed. The foregoing transfer functions can be embedded in an ACD of the survey system 102 or the service center 108 of step 206. Once the calling party 104 has been transferred, the survey system 102 proceeds to step 208.

If the calling party 108 has accepted the survey request as determined by step 208, then the survey system 102 proceeds in a first embodiment to step 214. In this embodiment, the calling party 104 is engaged in a survey in step 214 once s/he has completed one or more tasks at the service center 108. Said tasks can represent a partial or completed transaction of the calling party 104 at the service center 108. The survey questions can be chosen according to the tasks performed by the calling party 104 such as, for example, a survey based on billing inquiries, or account status inquiries, or change of service request, just to mention a few.

In an alternative embodiment, the survey system 102 monitors the behavior of the calling party 104 in step 209 by receiving from the service center 108 information corresponding to the tasks performed by the calling party 104. In step 210, the survey system 102 models an expected behavior of the calling party 104 and constructs in step 211 survey questions according to the expected behavior and observed behavior of the calling party 104 at the service center 108. Any modeling technique can be utilized in step 210 such as, for example, statistical methods, gaming theory, or other present and future modeling methods. The survey questions can be taken from portions of a predetermined survey list of words, clauses, phrases and sentences. The construction of this list can be tightly coupled with the modeling method chosen. Thus, step 211 provides a very effective real-time means for gathering feedback from the calling party 104 as s/he is transacting with a service center 108.

In step 212, the survey system 102 can send a request to the service center 108 to grant access to the calling party 104 to conduct the survey. The point of entry can occur at any time the survey system 102 determines it is appropriate to conduct a survey with the calling party 104. Thus, for example, a request can be made to survey the calling party 104 in the midst or at the end of a transaction depending on the determinations made by the modeling step 210 and construction step 211.

It should be noted that the foregoing steps 209-212 can be performed by maintaining multiple telephony trunks open between the calling party 104 and the service center 108. Alternatively, said steps can be performed in the background with an IP (Internet Protocol) backbone that couples the survey system 102 and the service centers 108. This latter approach can be more cost effective although potentially more complex to implement. It will be appreciated by one of ordinary skill in the art that the survey system 102 can utilize any method for monitoring the behavior of the calling party 104 as contemplated by the scope and spirit of the claims described herein.

In step 214 the calling party 104 engages in the survey as generated by step 211 or from a predetermined survey associated with the task performed by the calling party. As noted earlier in step 205, the calling party 104 is provided an opt-out option. If the calling party invokes an exit sequence (e.g., “*#”), the engagement step 214 terminates and the survey system 102 proceeds to step 218 as shown by the dashed line. The survey in step 214 can be conducted by verbal as well as DTMF responses. If and when the calling party 104 completes the survey in this step, the results are recorded in the database 102B of the survey system 102, and analyzed by, for example, by conventional automated modeling techniques and/or by service personnel with expertise in analyzing such data. The results of the analysis are then used for adjusting the business practices of the service center 108, thereby improving their efficiency, quality of service, and customer care.

In step 218, a determination is made whether the calling party 102 requires further assistance. If not, then method 200 ends, else said method repeats from step 206. The survey method can be repeated for each iteration of services provided to the calling party 104, or in a single cycle depending on what was agreed to in steps 204 and 205. It should be noted that had the calling party 104 rejected the survey request in step 208, the calling party would have been directed to step 218.

It should be evident by now that the present invention can be realized in hardware, software, or a combination of hardware and software. Moreover, the present invention can be realized in a centralized fashion, or in a distributed fashion where different elements are spread across several interconnected processors. Any kind of computing device or other apparatus adapted for carrying out method 200 described above is suitable for the present invention.

Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form. It should be also evident that the present invention may be used for many applications. Thus, although the description is made for particular arrangements and methods, the intent and concept of the invention is suitable and applicable to other arrangements and applications not described herein. For example, method 200 can be reduced to steps 202, 204, 206, 208 and 214 without departing from the scope and spirit of the claimed invention. This is but one of many embodiments that can be derived from modifications of method 200. It would be clear therefore to those skilled in the art that modifications to the disclosed embodiments described herein could be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A computer-readable storage medium coupled to one or more service centers, the storage medium comprising computer instructions for:
intercepting a calling party prior to the calling party accessing a service center;
informing the calling party of a survey request;
receiving from the calling party acceptance or rejection of the survey request;
transferring the calling party to the service center; and
engaging the calling party in a survey after the calling party completes one or more tasks at the service center so long as said calling party chose to accept the survey request.

2. The storage medium of claim 1, further comprises computer instructions for offering the calling party one or more incentives to motivate the calling party to accept the survey request.

3. The storage medium of claim 1, further comprising computer instructions for:
modeling an expected behavior of one or more tasks performed by a calling party at each of the one or more service centers;
wherein the engaging step further comprises computer instructions for constructing one or more survey questions according to the expected behavior and observed behavior of the calling party at the service center; and
recording survey responses from the calling party.

4. The storage medium of claim 3, further comprises computer instructions for constructing the one or more survey questions from portions of a predetermined survey list of words, clauses, phrases and sentences.

5. The storage medium of claim 1, further comprises computer instructions for selecting the calling party from a plurality of calling parties according to one or more business rules.

6. The storage medium of claim 5, wherein the one or more business rules are selected from at least one of a group comprising a classification of the calling party, a region of the calling party, a random selection of the calling party, a portion of a phone number of the calling party, and an identification of the calling party.

7. The storage medium of claim 1, further comprises computer instructions for providing the calling party a means for opting out of a survey at any time during the engaging step.

8. The storage medium of claim 3, further comprising computer instructions for monitoring a behavior of the calling party at the service center.

9. The storage medium of claim 8, further comprises computer instructions for:
receiving from the service center information corresponding to one or more tasks performed by the calling party; and
sending a request to the service center to grant access to the calling party for invoking the engaging step.

10. A survey system coupled to one or more service centers, comprising:
a memory; and
a processor coupled to the memory, wherein the processor is programmed to:
intercept a calling party prior to the calling party accessing a service center;
inform the calling party of a survey request;
receive from the calling party acceptance or rejection of the survey request;
transfer the calling party to the service center; and
engage the calling party in a survey after the calling party completes one or more tasks at the service center so long as said calling party chose to accept the survey request in the receive step.

11. The survey system of claim 10, the processor is further programmed to offer the calling party one or more incentives to motivate the calling party to accept the survey request.

12. The survey system of claim 10, wherein the processor is further programmed to:
model an expected behavior of one or more tasks performed by a calling party at each of the one or more service centers; and
wherein the engage step the processor is further programmed to construct one or more survey questions according to the expected behavior and observed behavior of the calling party at the service center; and
record survey responses from the calling party.

13. The survey system of claim 12, the processor is further programmed to construct the one or more survey questions from portions of a predetermined survey list of words, clauses, phrases and sentences.

14. The survey system of claim 10, the processor is further programmed to select the calling party from a plurality of calling parties according to one or more business rules, wherein the one or more business rules are selected from at least one of a group comprising a classification of the calling party, a region of the calling party, a random selection of the calling party, a portion of a phone number of the calling party, and an identification of the calling party.

15. The survey system of claim 10, the processor is further programmed to provide the calling party a means for opting out of a survey at any time during the engaging step.

16. The survey system of claim 10, wherein the one or more service centers includes at least one among a group of centers comprising one or more interactive voice response (IVR) systems each tailored to provide one or more calling parties a specific service, and one or more agents each trained to provide said calling parties a similar service.

17. The survey system of claim 12, wherein the processor is further programmed to:
receive from the service center information corresponding to one or more tasks performed by the calling party; and
send a request to the service center to grant access to the calling party for invoking the engaging step.

18. A method for conducting surveys, comprising the steps of:
intercepting a calling party prior to the calling party accessing a service center;
informing the calling party of a survey request;
offering the calling party one or more incentives to motivate the calling party to accept the survey request;
receiving from the calling party acceptance or rejection of the survey request;
transferring the calling party to the service center; and
engaging the calling party in a survey after the calling party completes one or more tasks at the service center so long as said calling party chose to accept the survey request.

19. The method of claim 18, further comprising the steps of:
modeling an expected behavior of one or more tasks performed by a calling party at each of the one or more service centers;
wherein the engaging step further comprises the step of constructing one or more survey questions according to the expected behavior and observed behavior of the calling party at the service center, and wherein the one or more survey questions are constructed from portions of a predetermined survey list of words, clauses, phrases and sentences;
recording survey responses from the calling party; and
adjusting business practices of each of the one or more service centers according to the survey responses.

20. The method of claim 19, further comprising the steps of:
receiving from the service center information corresponding to one or more tasks performed by the calling party; and
sending a request to the service center to grant access to the calling party for invoking the engaging step.
